(19) United States
(12) Patent Application Publication
(10) Pub. No.: US 2023/0112382 A1
(43) Pub. Date: Apr. 13, 2023

(54) RESISTIVE CURRENT COLLECTOR COATING

(71) Applicant: Medtronic, Inc., Minneapolis, MN (US)

(72) Inventor: Parthasarathy M. Gomadam, Plymouth, MN (US)

(21) Appl. No.: 17/892,900

(22) Filed: Aug. 22, 2022

Related U.S. Application Data
(60) Provisional application No. 63/250,585, filed on Sep. 30, 2021.

(51) Int. Cl. H01M 4/04; H01M 50/46

(52) U.S. Cl. CPC H01M 4/0404; H01M 50/461

(57) ABSTRACT

An electrochemical cell includes a positive electrode including a first current collector, one or more first tabs, and a first active material. A negative electrode includes a second current collector, one or more second tabs, and a second active material. A separator is disposed between the positive electrode and the negative electrode. A resistive coating is configured to at least partially coat one or both of the first current collector, the second current collector, the one or more first tabs, and the one or more second tabs.

### RELATED PATENT APPLICATION

This application claims the benefit of U.S. Provisional Pat. Application Serial No. 63/250,585, filed on Sep. 30, 2021, which is incorporated by reference herein in its entirety.

### FIELD

The present disclosure is generally related to batteries. More specifically, the present technology relates to a current collector coating for improved battery safety.

### BACKGROUND

Electrochemical cells include one or more positive electrodes, one or more negative electrodes, and an electrolyte provided within a case or housing. Separators made from a porous polymer or other suitable material may also be provided intermediate or between the positive and negative electrodes to prevent direct contact between adjacent electrodes. The positive electrode includes a current collector having an active material provided thereon, and the negative electrode includes a current collector having an active material provided thereon.

### SUMMARY

Embodiments described herein involve an electrochemical cell comprising a positive electrode comprising a first current collector, one or more first tabs, and a first active material. A negative electrode comprises a second current collector, one or more second tabs, and a second active material. A separator is disposed between the positive electrode and the negative electrode. A resistive coating is configured to at least partially coat one or both of the first current collector, the second current collector, the one or more first tabs, and the one or more second tabs.

Embodiments involve a positive electrode comprising a first current collector and a first active material. A negative electrode comprises a second current collector comprising a second active material. A separator is disposed between the positive electrode and the negative electrode. A resistive coating is configured to at least partially coat a surface of one or both of the first current collector and the second current collector.

A method involves providing an electrochemical cell comprising a positive electrode comprising a first current collector comprising one or more first tabs and a negative electrode comprising a second current collector comprising one or more second tabs, A resistive coating at least partially covers at least one of the first current collector, the second current collector, the one or more first tabs, and the one or more second tabs.

Advantages and additional features of the subject matter of the present disclosure will be set forth in the detailed description which follows, and in part will be readily apparent to those skilled in the art from that description or recognized by practicing the subject matter of the present disclosure as described herein, including the detailed description which follows, the claims, as well as the appended drawings.

It is to be understood that both the foregoing general description and the following detailed description present embodiments of the subject matter of the present disclosure, and are intended to provide an overview or framework for understanding the nature and character of the subject matter of the present disclosure as it is claimed. The accompanying drawings are included to provide a further understanding of the subject matter of the present disclosure and are incorporated into and constitute a part of this specification. The drawings illustrate various embodiments of the subject matter of the present disclosure and together with the description serve to explain the principles and operations of the subject matter of the present disclosure. Additionally, the drawings and descriptions are meant to be merely illustrative and are not intended to limit the scope of the claims in any manner.

### BRIEF DESCRIPTION OF THE DRAWINGS

The following detailed description of specific embodiments of the present disclosure can be best understood when read in conjunction with the following drawings, in which:

FIG. 1 is a schematic cross-sectional view of a portion of a battery or cell according to an exemplary embodiment that includes at least one positive electrode and at least one negative electrode in accordance with embodiments described herein;

FIG. 2 shows an example current collector 210 having a coating 220 disposed thereon in accordance with embodiments described herein;

FIG. 3 shows a cross-section of a current collector with a resistive coating in accordance with embodiments described herein;

FIGS. 4A and 4B shows an example current collector 410 having a coating 420 disposed thereon in accordance with embodiments described herein;

FIGS. 5A - 5D show examples of other coating configurations in accordance with embodiments described herein; and

FIG. 6 illustrates a method for applying a resistive coating to a current collector in accordance with embodiments described herein.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Reference will now be made in greater detail to various embodiments of the subject matter of the present disclosure, some embodiments of which are illustrated in the accompanying drawings. Like numbers used in the figures refer to like components and steps. However, it will be understood that the use of a number to refer to a component in a given figure is not intended to limit the component in another figure labeled with the same number. In addition, the use of different numbers to refer to components in different figures is not intended to indicate that the different numbered components cannot be the same or similar to other numbered components.

Devices such as batteries have two electrodes at different potentials, which when shorted results in a rush of current that may cause local and global heating, with the magnitudes depending on the nature of the device and the short. In batteries, for example, these shorts - internal and external to the battery - can cause heating to the level of triggering exothermic chemical reactions in the battery and lead to thermal runaway, which in turn could cause serious safety hazards. The amount of heat generated, the rate of heat generated, the location of heat generated may be some of the key factors determining the temperature reached by any point in the battery. To mitigate this, several approaches are taken in terms of battery design, material choice, electronics design, process control, electronic and thermal management systems, for example.

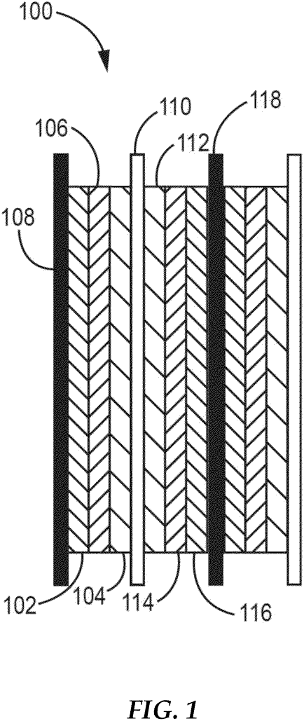

FIG. 1 is a diagram of an example electrochemical cell 100 in accordance with embodiments. The electrochemical cell 100 includes at least one first electrode 102 separated from a second electrode 104 by a shutdown separator 106. The first electrode 102 can comprise a first current collector 108 substrate having a first active material composite layered thereon. The first current collector 108 can be substantially planar, or the first current collector 108 can be curved, although embodiments are not limited thereto. The second electrode 104 can comprise a second current collector 110 substrate parallel to the first current collector 108 substrate. The second current collector 110 substrate can have a second active material composite layered thereon. The second current collector 110 can be substantially planar, although embodiments are not limited to planar current collectors. More than one set of electrodes can be included in the electrochemical cell 100. For example, current collector 110 can have active material disposed thereon to form a third electrode 112. A second shutdown separator 114 can separate third electrode 112 from fourth electrode 116. Fourth electrode 116 can be formed by disposing active material on current collector 118. While FIG. 1 illustrates a planar cell 100 embodiments are not limited thereto. Other embodiments include but are not limited to the cell being coiled or rolled up.

The shutdown separator 106 can be resistant to heat distortion. The shutdown separator 106 shall be porous such that lithium ions can pass through the shutdown separator. The shutdown separator 106 shall include a polymer or other material that melts or deforms at high temperatures to close pores of the shutdown separator 106. This pore shutdown shall prevent passage of lithium ions, shutting down the electrochemical cell 100 current to zero or nearly zero. In some examples, a subset of shutdown separators 106 will shut down.

In some examples, the first electrode 102 can be a negative electrode and the second electrode 104 can be a positive electrode. Positive electrodes 104 can include an active material and a sheet-form current collector (e.g., current collector 110) carrying the active material. The positive electrode current collector 110, can typically comprise a metal but is not limited thereto. For the positive electrode 104, 112 active material, various materials can be used. The positive electrode 104 can include a material mixture carried on the current collector 110, the material mixture including a positive electrode active material and a small amount of a binder or a conductive material. Positive electrode 104 active material can include lithium-containing transition metal oxides such as lithium cobalt oxide, lithium nickel oxide, and lithium manganese oxide. The binder material can include polytetrafluoroethylene (PTFE) or rubber materials. Negative electrode 102 can include an active material and a sheet-form current collector 108 carrying the active material. The negative electrode current collector 108 can typically comprise a metal but is not limited thereto. The negative electrode active material can include carbon materials (for example, graphite), a silicon material or silicon alloy, a tin material or a tin alloy, and lithium metal. The lithium metal can include a lithium alloy including metal elements such as aluminum, zinc or magnesium. The negative electrode 102 binder material can include the same or similar material as used in the positive electrode 104 binder material.

Current collectors (e.g., current collector 108 and 110) may include current collector tabs (not shown), which are coupled, typically by welding, to respective current collectors and then provided outside the battery cell casing so that the electrochemical cell 100 energy can be transferred to an external source. In some embodiments, one or more of the current collectors may extend beyond the electrode coating region and may not have any tabs attached.

Embodiments described herein involve a battery design and/or material choice approach that could help mitigate local and global battery temperatures in all safety events in general, as well as external and/or internal shorts. This mitigation may be especially beneficial in the cases of highly conductive (typically, metallic) internal shorts bridging the highly conductive (typically, metallic) parts of the two electrodes. Coating one or both of the current collectors and/or one or both sets of tabs with a material having specific electrical properties and design significantly reduces the local temperatures, making the battery much safer.

Coating one or both current collectors and/or one or both sets of tabs with a material that is of an optimum resistance and of an optimum thickness (balancing between resistance and safety) - stable over battery life - of good mechanical integrity under shorting conditions. When a highly conductive short bridges the highly conductive parts of the two electrodes, the short resistance is so small that typically large currents rush through the short increasing the local temperature to greater than even several hundreds of degrees centigrade. This, being higher than the onset temperatures of exothermic reactions between battery components, could easily trigger those reactions due to which severe safety hazards including battery explosion could happen. However, if there is a resistive coating intervening the short and the current collector, the rush current magnitude and the temperatures reached are greatly reduced, as a result of which the likelihood of triggering exothermic reactions is greatly reduced.

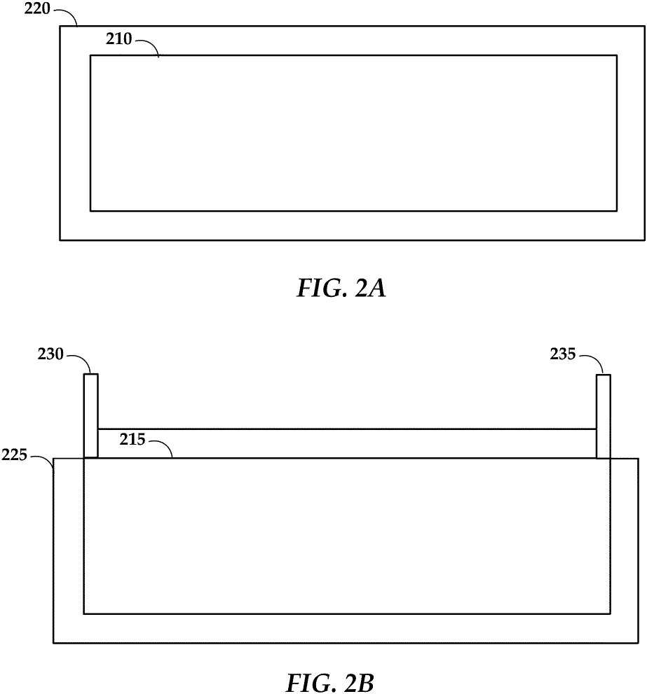

FIG. 2A shows an example cross-section of a current collector 210 having a coating 220 disposed thereon in accordance with embodiments described herein. In this example, the coating is applied to substantially the entire surface area of the current collector. In some cases, the coating 225 is applied to substantially the entire surface area of the current collector 215 except for the tabs 230, 235 protruding from the current collector as shown in FIG. 2B. The coating may be applied to one or both of the first current collector and the second current collector. In some cases, the resistive coating is disposed on any surface of the current collector and/or the tabs.

One or more of the material, thickness, and/or resistance of the coating may be chosen to prevent and/or substantially reduce internal shorts between the positive electrode and the negative electrode. In some cases, one or more of the material, thickness, and/or resistance of the coating is chosen to prevent and/or substantially reduce thermal runaway of the electrochemical cell.

According to various embodiments described herein, a material of the coating is chosen to have an electrical conductivity that balances safety with efficacy. The coating material may be chosen to have a resistance that is between that of one or both of the electrode materials and the current collector materials. In some cases, the coating material may be chosen to have a resistance that is between that of the negative electrode and that of one or both of the current collectors. For example, the coating material may be chosen to be one or more carbon-based materials. For example, the coating material may comprise one or more of carbon, PVDF, PTFE, and/or mixtures thereof. The conductivity of the coating material may be in a range of about 1e-5 S/m to about 10,000 S/m. In some cases, the conductivity of the coating material may be in a range of about 0.01 S/m to about 100 S/m. It is to be understood that the coating material and/or conductivity may be the same or different for the first current collector and the second current collector. In some cases, the coating material and/or conductivity may vary across the surface of a current collector. In some cases, the coating may be made only on parts of the current collectors or tabs.

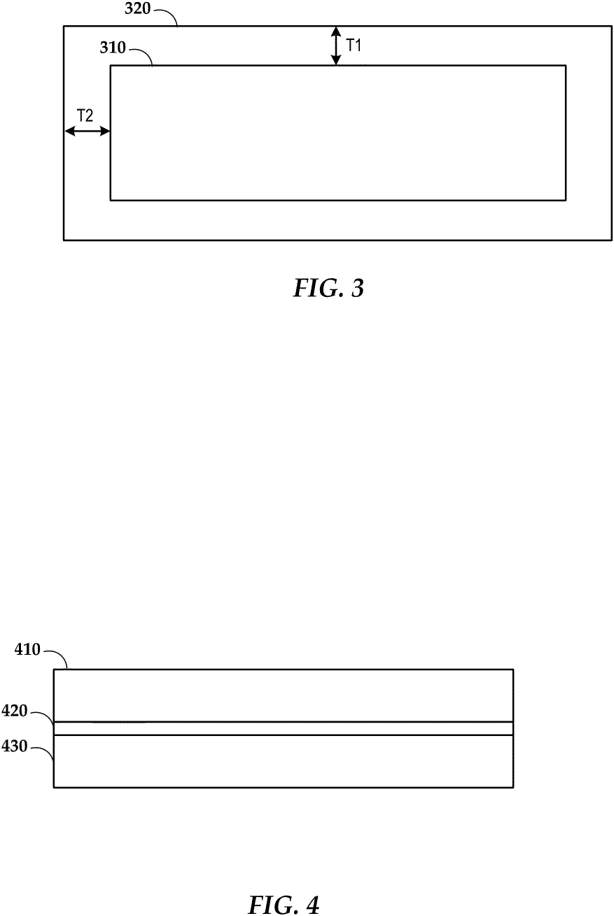

A thickness of the coating is chosen to have a thickness that balances safety with efficacy. FIG. 3 shows a cross-section of a current collector with a resistive coating in accordance with embodiments described herein. In this example, a current collector 310 with a coating 320 is shown. The thickness, T1, T2, of the coating may be in a range of about 0.1 microns to about 100 microns. In some cases, the thickness of the coating may be in a range of about 1 micron to about 10 microns. According to various configurations, T1 and T2 are different. In some cases, T1 and T2 are substantially the same. It is to be understood that the coating thickness may be the same or different for the first current collector and the second current collector. In some cases, the thickness may vary across the surface of a current collector.

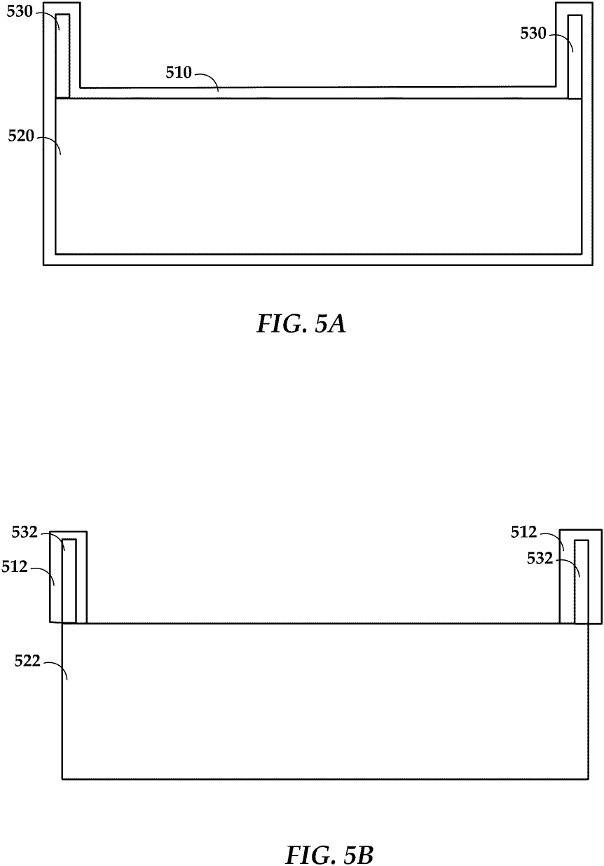

FIGS. 4A and 4B shows an example current collector 410 having a coating 420 disposed thereon in accordance with embodiments described herein. The coating 420 may be applied to one or both of the first current collector and the second current collector. In this example, the coating is disposed at least on a planar side of the current collector 410 facing the respective electrode active material 430 as shown in FIG. 4B. In some cases, a surface treatment is applied to the resistive coating to promote coating integrity.

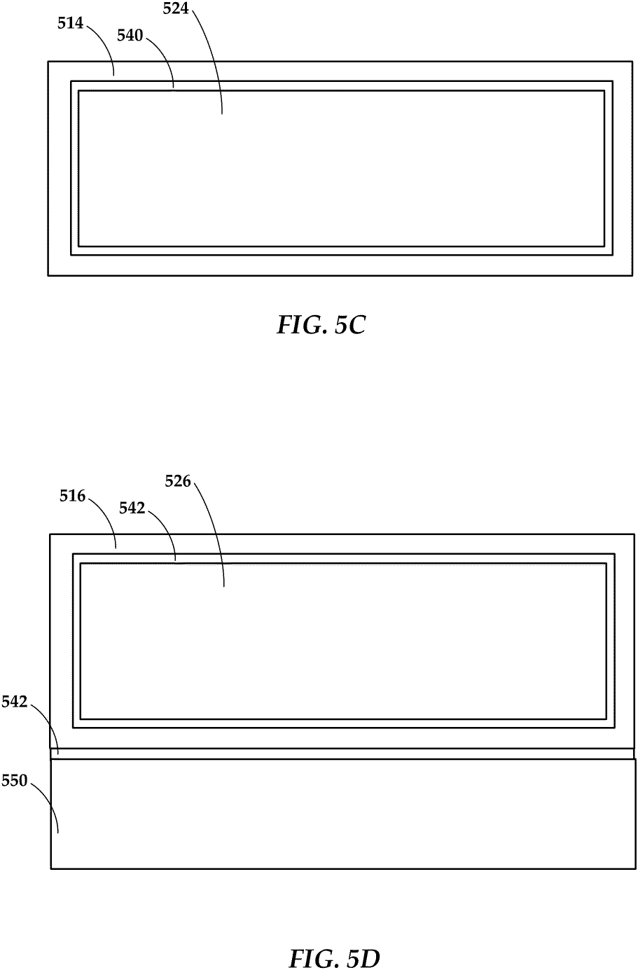

FIGS. 5A - 5D show examples of other coating configurations in accordance with embodiments described herein. FIG. 5A illustrates an example in which the resistive coating 510 is disposed on the current collector 520 and the tabs 530. According to various embodiments the resistive coating 510 has a different thickness on the tabs 530 than on the current collector 520. In some cases, the thickness of the resistive coating 510 is substantially the same on the tabs 530 and the current collector 520. In some cases, the resistive coating may be disposed on only the tabs and not on a surface of the current collector. FIG. 5B shows a current collector 522 and one or more tabs 532. A resistive coating 502 disposed on the one or more tabs 532. While FIGS. 5A and 5B illustrate an example in which the resistive coating is disposed on both tabs, it is to be understood that the resistive coating may be disposed on only one tab and/or partially on one or both of the tabs. In some cases, there may not be any tabs attached to the current collector extending in some cases beyond the electrode coating, where too the resistive coating may be fully or partially disposed.

FIG. 5C illustrates an example in which an adhesion layer 540 is disposed between the resistive coating 514 and the current collector 524 and/or tabs 534. The adhesion layer 540 may help to promote adhesion between the resistive coating 514 and the current collector 524 and/or tabs. FIG. 5C illustrates an example where an adhesion layer is disposed on both sides of the resistive coating. The first adhesion layer 542 is disposed on a first side of the resistive coating 516 may help to promote adhesion between the resistive coating 516 and the current collector 526 and/or tabs. A second adhesion layer 544 may be disposed on an opposite side of the resistive coating 516. The second adhesion layer 544 may be used to promote adhesion between the resistive coating 516 and one or more adjacent structures. For example, the second adhesion layer 544 may be used to promote adhesion between the resistive coating 516 and an active layer 550 of the electrode. The adhesion material may comprise one or more of carbon, PVDF, PTFE, and/or mixtures thereof.

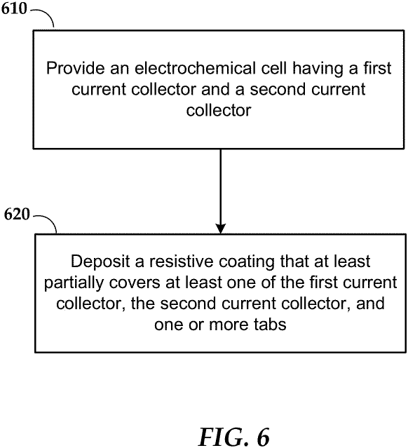

FIG. 6 illustrates a method for applying a resistive coating to a current collector in accordance with embodiments described herein. An electrochemical cell comprising a positive electrode comprising a first current collector and a negative electrode comprising a second current collector is provided 610. A resistive coating is deposited 620 that at least partially covers at least one of the first current collector and the second current collector and or one or more of the tabs.

The invention is defined in the claims. However, below there is provided a non-exhaustive list of non-limiting examples. Any one or more of the features of these examples may be combined with any one or more features of another example, embodiment, or aspect described herein.

Example Ex1: An electrochemical cell comprising: a positive electrode comprising a first current collector, attached to none, one or more first tabs, and a first active material; a negative electrode comprising a second current collector, attached to none, one or more second tabs, and a second active material; a separator disposed between the positive electrode and the negative electrode; and a resistive coating configured to at least partially coat one or both of the first current collector, the second current collector, the one or more first tabs, and the one or more second tabs.

Example Ex2: The electrochemical cell as in example Ex1, wherein the resistive coating is chosen to prevent internal shorts between the first electrode and the second electrode.

Example Ex3: The electrochemical cell as in any one of examples Ex1 to Ex2, wherein the resistive coating is chosen to prevent thermal runaway of the electrochemical cell.

Example Ex4: The electrochemical cell as in any one of examples Ex1 to Ex3, wherein the resistive coating comprises one or more of use carbon, PVDF, and PTFE.

Example Ex5: The electrochemical cell as in any one of examples Ex1 to Ex4, wherein the resistive coating has a thickness in a range of about Example Ex0: 1 microns to about 100 microns.

Example Ex6: The electrochemical cell as in any one of examples Ex1 to Ex5, wherein the resistive coating has a thickness in a range of about 1 microns to about 10 microns.

Example Ex7: The electrochemical cell as in any one of examples Ex1 to Ex6, wherein the resistive coating has a conductivity in a range of about 1e-5 S/m to about 10,000 S/m.

Example Ex8: The electrochemical cell as in any one of examples Ex1 to Ex7, wherein the resistive coating has a conductivity in a range of about Example Ex0:01 S/m to about 100 S/m.

Example Ex9: The electrochemical cell as in any one of examples Ex1 to Ex8, wherein the resistive coating has a resistance in a range between a resistance of the negative electrode and the resistance of one or both of the first current collector and the second current collector, the one or more first tabs if any, and the one or more second tabs if any.

Example Ex10: The electrochemical cell as in any one of examples Ex1 to Ex9, wherein none, one or more first tabs and none, one or more second tabs are configured to transfer energy from the electrochemical cell to an external source.

Example Ex11: The electrochemical cell as in any one of examples Ex1 to Ex10, wherein the resistive coating is configured to substantially coat all of one or both of the first and the second current collector except for a location of one or more tabs if any.

Example Ex12: The electrochemical cell as in any one of examples Ex1 to Ex10, wherein the resistive coating is configured to substantially coat one or more first tabs if any and the one or more second tabs if any.

Example Ex13: The electrochemical cell as in any one of examples Ex1 to Ex10, wherein the resistive coating is configured to substantially coat all of one or both of the first and the second current collector.

Example Ex14: The electrochemical cell as in any one of examples Ex1 to Ex10, wherein the resistive coating is configured to coat at least one planar surface of one or both of the first current collector and the second current collector.

Example Ex15: The electrochemical cell as in example Ex14, wherein at least one planar surface faces a respective active material.

Example Ex16: The electrochemical cell as in any one of examples Ex1 to Ex15, further comprising one or more adhesion layers proximate to the resistive coating, the one or more adhesion layers configured to promote adhesion between the resistive coating and an adjacent structure.

Example Ex17: An electrochemical cell comprising: a positive electrode comprising a first current collector and a first active material; a negative electrode comprising a second current collector comprising a second active material; a separator disposed between the positive electrode and the negative electrode; and a resistive coating configured to at least partially coat a surface of one or both of the first current collector and the second current collector

Example Ex18: A method, comprising: providing an electrochemical cell comprising a positive electrode comprising a first current collector comprising one or more first tabs if any and a negative electrode comprising a second current collector comprising one or more second tabs if any; and depositing a resistive coating that at least partially covers at least one of the first current collector, the second current collector, one or more first tabs, and one or more second tabs.

Example Ex19: The method as in example Ex18, further comprising welding one or more tabs to the first current collector and the second current collector.

Example Ex20: The method as in example Ex19 wherein the resistive coating is configured to substantially coat all of one or both of the first and the second current collector except for a location of the one or more tabs.

All scientific and technical terms used herein have meanings commonly used in the art unless otherwise specified. The definitions provided herein are to facilitate understanding of certain terms used frequently herein and are not meant to limit the scope of the present disclosure.

As used herein, singular forms “a,” “an” and “the” include plural referents unless the context clearly dictates otherwise. As used in this specification and the appended claims, the term “or” is generally employed in its sense including “and/or” unless the content clearly dictates otherwise. The term “and/or” means one or all of the listed elements or a combination of any two or more of the listed elements.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the inventive technology.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred. Any recited single or multiple feature or aspect in any one claim can be combined or permuted with any other recited feature or aspect in any other claim or claims.

It will be apparent to those skilled in the art that various modifications and variations can be made to the present inventive technology without departing from the spirit and scope of the disclosure. Since modifications, combinations, sub-combinations and variations of the disclosed embodiments incorporating the spirit and substance of the inventive technology may occur to persons skilled in the art, the inventive technology should be construed to include everything within the scope of the appended claims and their equivalents.

What is claimed is:

1. An electrochemical cell comprising:
a positive electrode comprising a first current collector, attached to none, one or more first tabs, and a first active material;
a negative electrode comprising a second current collector, attached to none, one or more second tabs, and a second active material;
a separator disposed between the positive electrode and the negative electrode; and
a resistive coating configured to at least partially coat one or both of the first current collector, the second current collector, the one or more first tabs, and the one or more second tabs.

2. The electrochemical cell of claim 1, wherein the resistive coating is chosen to prevent internal shorts between the first electrode and the second electrode.

3. The electrochemical cell of claim 1, wherein the resistive coating is chosen to prevent thermal runaway of the electrochemical cell.

4. The electrochemical cell of claim 1, wherein the resistive coating comprises one or more of use carbon, PVDF, and PTFE.

5. The electrochemical cell of claim 1, wherein the resistive coating has a thickness in a range of about 0.1 microns to about 100 microns.

6. The electrochemical cell of claim 1, wherein the resistive coating has a thickness in a range of about 1 microns to about 10 microns.

7. The electrochemical cell of claim 1, wherein the resistive coating has a conductivity in a range of about 1e-5 S/m to about 10,000 S/m.

8. The electrochemical cell of claim 1, wherein the resistive coating has a conductivity in a range of about 0.01 S/m to about 100 S/m.

9. The electrochemical cell of claim 1, wherein the resistive coating has a resistance in a range between a resistance of the negative electrode and the resistance of one or both of the first current collector and the second current collector, the one or more first tabs if any, and the one or more second tabs if any.

10. The electrochemical cell of claim 1, wherein none, one or more first tabs and none, one or more second tabs are configured to transfer energy from the electrochemical cell to an external source.

11. The electrochemical cell of claim 1, wherein the resistive coating is configured to substantially coat all of one or both of the first and the second current collector except for a location of one or more tabs if any.

12. The electrochemical cell of claim 1, wherein the resistive coating is configured to substantially coat one or more first tabs if any and the one or more second tabs if any.

13. The electrochemical cell of claim 1, wherein the resistive coating is configured to substantially coat all of one or both of the first and the second current collector.

14. The electrochemical cell of claim 1, wherein the resistive coating is configured to coat at least one planar surface of one or both of the first current collector and the second current collector.

15. The electrochemical cell of claim 14, wherein at least one planar surface faces a respective active material.

16. The electrochemical cell of claim 1, further comprising one or more adhesion layers proximate to the resistive coating, the one or more adhesion layers configured to promote adhesion between the resistive coating and an adjacent structure.

17. An electrochemical cell comprising:
a positive electrode comprising a first current collector and a first active material;
a negative electrode comprising a second current collector comprising a second active material;
a separator disposed between the positive electrode and the negative electrode; and
a resistive coating configured to at least partially coat a surface of one or both of the first current collector and the second current collector.

18. A method, comprising:
providing an electrochemical cell comprising a positive electrode comprising a first current collector comprising one or more first tabs if any and a negative electrode comprising a second current collector comprising one or more second tabs if any; and
depositing a resistive coating that at least partially covers at least one of the first current collector, the second current collector, one or more first tabs, and one or more second tabs.

19. The method of claim 18, further comprising welding one or more tabs to the first current collector and the second current collector.

20. The method of claim 19 wherein the resistive coating is configured to substantially coat all of one or both of the first and the second current collector except for a location of the one or more tabs.
